(19) United States
(12) Patent Application Publication
(10) Pub. No.: US 2008/0235394 A1
(43) Pub. Date: Sep. 25, 2008

(54) Secure Document Management System

(75) Inventor: John Olive, Coral Springs, FL (US)

Correspondence Address: TECHNOLOGY, PATENTS AND LICENSING, INC., 2003 South EASTON ROAD, SUITE 208, DOYLESTOWN, PA, 18901, US

(73) Assignee: DOCommand Solution, Inc.

(21) Appl. No.: 11/688,394

(22) Filed: Mar. 20, 2007

(51) Int. Cl. G06F 15/16; G06F 17/30

(52) U.S. Cl. 709/238; 709/217; 707/10

(57) ABSTRACT

A method of uploading documents to a secure electronic document storage system includes receiving a request from a user for an upload of at least one document to a secure electronic document storage system. A routing document is generated including routing information related to the secure electronic document storage system. The routing document is transmitted to the user. The secure electronic document storage system receives a facsimile transmission from the user, wherein the facsimile transmission includes the routing document and at least one other document. The at least one document is routed to the secure electronic document storage system, based on the routing information contained in the routing document.

### CROSS REFERENCE TO RELATED APPLICATIONS

This application is related to co-pending U.S. patent application Ser. No. ______, filed Mar. 20, 2007, entitled Secure Document Management System, Attorney Docket No. DOC-001-1; U.S. patent application Ser. No. ______, filed Mar. 20, 2007, entitled Secure Document Management System, Attorney Docket No. DOC-001-3; and U.S. patent application Ser. No. ______, filed Mar. 20, 2007, entitled Secure Document Management System, Attorney Docket No. DOC-001-4.

### BRIEF DESCRIPTION OF THE DRAWINGS

The following detailed description will be better understood when read in conjunction with the appended drawings, in which there is shown one or more of the multiple embodiments of the present invention. It should be understood, however, that the various embodiments of the present invention are not limited to the precise arrangements and instrumentalities shown in the drawings.

In the Drawings:

FIG. 1 is a system diagram in accordance with one embodiment of a document management system;

FIG. 2 is a system diagram in accordance with one embodiment of a document management system;

FIG. 3 is a use case diagram of a data management system in accordance with the document management system of FIGS. 1 and 2;

FIG. 4 is a use case diagram of an data management system in accordance with the document management system of FIGS. 1 and 2;

FIG. 5 is an activity diagram of a login process in accordance with the document management system of FIGS. 1 and 2;

FIG. 6 is an example of a graphical user interface in accordance with the document management system of FIGS. 1 and 2;

FIG. 7 is an activity diagram a facsimile uploading process in accordance with the document management system of FIGS. 1 and 2;

FIG. 8 is an example of a graphical user interface in accordance with the document management system of FIGS. 1 and 2;

FIG. 9 is an example of a graphical user interface in accordance with the document management system of FIGS. 1 and 2;

FIG. 10 is an example of a graphical user interface in accordance with the document management system of FIGS. 1 and 2; and

FIG. 11 is an example of a graphical user interface in accordance with the document management system of FIGS. 1 and 2.

### DETAILED DESCRIPTION

Certain terminology is used herein for convenience only and is not to be taken as a limitation on the embodiments of the present invention. In the drawings, the same reference letters are employed for designating the same elements throughout the several figures.

The words “right”, “left”, “lower” and “upper” designate directions in the drawings to which reference is made. The words “inwardly” and “outwardly” refer to directions toward and away from, respectively, the geometric center of the weather determination system and designated parts thereof. The terminology includes the words above specifically mentioned, derivatives thereof and words of similar import.

Unified Modeling Language (“UML”) can be used to model and/or describe methods and systems and provide the basis for better understanding their functionality and internal operation as well as describing interfaces with external components, systems and people using standardized notation. When used herein, UML diagrams including, but not limited to, use case diagrams, class diagrams and activity diagrams, are meant to serve as an aid in describing the embodiments of the present invention, but do not constrain implementation thereof to any particular hardware or software embodiments. Unless otherwise noted, the notation used with respect to the UML diagrams contained herein is consistent with the UML 2.0 specification or variants thereof and is understood by those skilled in the art.

The multiple embodiments of the present invention include a document management system that enables documents to be securely transferred to, stored in and retrieved from an Electronic Document Storage System (EDSS) through an electronic network. The document management system generally includes, and is unified with, a Data Management System (DMS) which contains information unrelated to the electronic document storage and an EDSS which contains electronic documents stored by a user. A user logs into the DMS and the login is securely transferred to the EDSS for retrieval of electronic documents previously stored in the EDSS. Additionally, the user can store electronic documents by electronically transferring or manually delivering documents to the EDSS. In a variety of other embodiments, various other systems may be utilized to facilitate document management, such as backend servers, security systems and other electronic systems to protect the security of the data being passed between the two systems. The documents may be uploaded to the EDSS through a variety of known data transfer methods including facsimile, e-mail, FTP, HTML and others. Additionally, the electronic documents or other files to be transferred to the EDSS may be in a variety of formats format including Portable Document Format (PDF), word processing files such as Microsoft® Word documents or picture files such as Joint Photographic Expert Group (JPEG) or Graphic Interchange Format (GIF) files. Similarly, the content of the files transferred may be any type of content that could be stored and/or transferred in any of the foregoing formats or protocols including birth certificates, passports, financial documents or any file or scanned copy of a physical document. The transferring to and from the EDSS can occur from anywhere in the world the user is located.

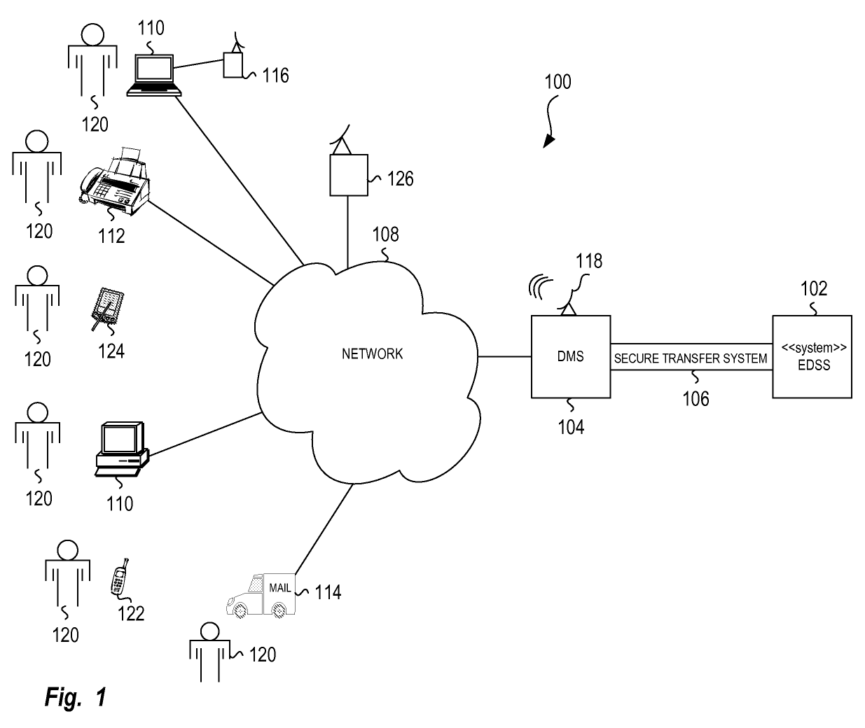

Referring to FIG. 1, a document management system 100 for securely retrieving documents from and storing documents to an EDSS 102 is shown. The document management system 100 receives, stores and provides documents originating from a plurality of users 120. In one embodiment, the EDSS 102 is a personal document registry system which maintains official documents and records belonging to the user 120. A registry is a storage location where official documents and official records such as passports, property titles and birth certificates are kept. The official documents and records may be kept as hard copies where soft copies are created by scanning the hard copies and storing the result on the EDSS 102. Alternatively, the official documents and records can be soft copies submitted by the user 120, where the hard copies are stored elsewhere. The EDSS 102 may be a computer with a hard drive, a server, an electronic storage device, a proprietary system or generally any other system or device known in the art capable of electronically storing, receiving and sending one or more documents or other files. Furthermore, the EDSS 102 may be broken down into various memory locations corresponding to various users through partitioning or filing structures. The users 120 may be individuals, companies, networks or other entities that provide documents to the document management system 100.

The document management system 100 includes a data management system (DMS) 104, which holds information about the user 120. In one embodiment, the DMS 104 is a system independent from the EDSS 102. The DMS 104 can be a website, a proprietary system accessed through a computer program, an application or an online database holding user data. The DMS 104 may hold different types of data depending on the implementation. In one implementation the DMS 104 is a membership data management system which manages data belonging to members of an organization. One example is a website or other system which maintains information related to customers or employees of a shopping establishment or users of a member organization or establishment such as a single grocery store, a price club or other large establishment with mass distribution channels, a social networking website or an employment website database system or some other commercial establishment. The DMS 104 may also be a financial data management system, which holds banking and other financial information related to a customer. For example, a financial data management system may include a website that customers of a bank log into to bank online and/or conduct other financial management activities. The DMS 104 may be a travel data management system that manages data belonging to travelers. In general, the DMS 104 may be any system which manages information belonging to a user. A user 120 accesses the DMS 104 to retrieve, view or alter the user data held on the DMS 104. Users 120 log into the DMS 104 through any login mechanism generally known in the art, such as a username and password. Once the DMS 104 receives the login from users 120, it authenticates the user. Users 120 log into the DMS 104 using personal computer 110, personal digital assistant (PDA) 124, Internet capable cell phone 122 or any other device capable of securely retrieving the user data from the DMS 104. Personal computer 110, PDA 124 and cell phone 122 connect to DMS 104 through network 108 and can be hard-wired into the network 108 through an Ethernet connection or similar standard or alternatively be wirelessly connected through an 802.11b connection, blue tooth, cell phone technology or other wireless standard. The network 108 may be the Internet, a local intranet, a direct connection, a cell phone network, a public switched telephone network (PSTN) or any other network capable of facilitating communication between users 120 and the DMS 104. Alternatively, personal computer 110 may connect to the DMS 104 through satellite dishes 116, 126 and 118 via a satellite (not shown), connecting the user 120 to the DMS 104 through either the network 108 or the DMS 104.

The user 120 gains access to the files contained in the EDSS 102 through the DMS 104 via a secure transfer system 106. The secure transfer system 106 is a connection between the DMS 104 and the EDSS 102 which securely passes data between the two systems. The secure transfer system 106 may use a variety of security mechanisms including encryption and digital signing. In one embodiment, the secure transfer system 106 includes an established Secure Socket Layer (SSL) or Transport Layer Security (TLS) connection which is initiated by the DMS 104 and confirmed by the EDSS 102, however any known secure connection may be used. The DMS 104 uses the above described security mechanisms to prepare the login information to be sent to the EDSS 102 through the secure transfer system 106. The EDSS 102 receives the login information from the DMS 104 and interprets the data. If encryption and digital signing is used, the interpreting includes decrypting the information as well as verifying the digital signature. The EDSS 102, using the information received from the DMS 104, allows the user 120 to access the EDSS 102, giving the user 120 the ability to view, download and upload electronic documents to the EDSS 102. It is not necessary for the administrators of the DMS 104 and the administrators of the EDSS 102 to be the same person or entity nor it is it necessary for the administrators of the DMS 104 to have access to the information contained on the EDSS 102. SSL and TLS are cryptographic protocols to provide secure communications between to networked entities. Generally, SSL and TLS prevent alteration, theft and other threats to security of data sent between two entities, while ensuring that messages sent between the two entities are in originating from the correct source. SSL and TLS are generally known by those skilled in the art of computer networking and network security. Similarly, the encryption and decryption used by the DMS 104 and EDSS 102 are generally known by a person skilled in the art. The encryption techniques can include public key cryptography using an RSA algorithm and private key cryptography as well as other encryption techniques known in the art. In general, any secure transfer protocol or other mechanism may be used by the secure transfer system 106.

Once the user 120 has been appropriately authorized and authenticated to the document management system 100, the user 120 can upload documents from any of the aforementioned devices, as well as from facsimile machine 112, to the EDSS 102. The user 120 can upload documents through a variety of methods including e-mail, Hyper Text Modeling Language (HTML), File Transfer Protocol (FTP) as well as any other method capable of electronically transferring documents or files. In the embodiment shown in FIG. 1, the personal computer 110 connects to the DMS 104 through the network 108. The DMS 104, which is connected to the EDSS 102 through the secure transfer system 106, applies the above described security to the document and routes it to the user's memory location of the EDSS 102. Alternatively, user 120 can use a facsimile transmission using facsimile 112 or can physically mail the document via a tradition mail service 114 to an organization which creates an electronic version of the document and uploads it to the user's memory location on the EDSS 102. The traditional mail service 114 may be the U.S. Postal Service, FedEx® or another similar carrier or service. The user 120 may also download and view documents already contained on the EDSS 102 through a similar process. The documents and files contained on the EDSS 102 may be transmitted electronically to the user 120 through an e-mail, HTML, FTP, facsimile or other electronic means. Alternatively, a physical copy of the document may be delivered via the traditional mail service 114 to the user 102.

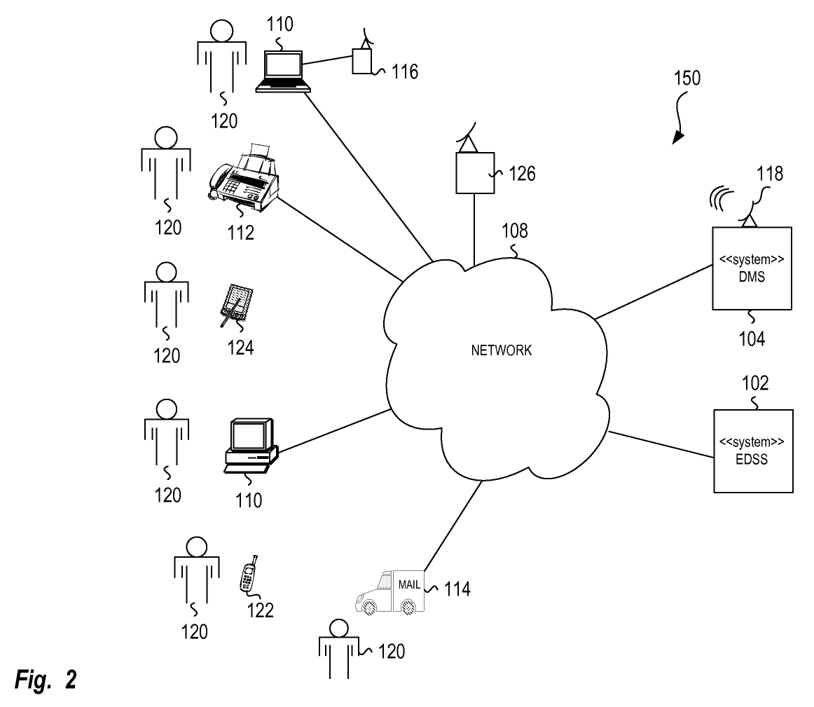

Referring to FIG. 2, an alternate embodiment of a document management system 150 is shown. Document management system 150 performs similar functions as that of the document management system 100 described in FIG. 1. Document management system 150 includes the EDSS 102, the DMS 104 and the network 108. However the connection between the DMS 104 and the EDSS 102 is facilitated through the use of the network 108, rather then through the secure transfer system 106. The EDSS 102 and the DMS 104 connect via the network 108 using security measures such as SSL or TSL as described above in FIG. 1. A user 120 gains access to the DMS 104 from the above described devices and the DMS 104 securely transfers the login to the EDSS 102 using the above described security methods. Once connected, the user 120 connects directly to the EDSS 102 to send, receive and view documents. In this embodiment, the documents sent and received from the EDSS 102 do not pass through the DMS 104 as in document management system 100 in FIG. 1.

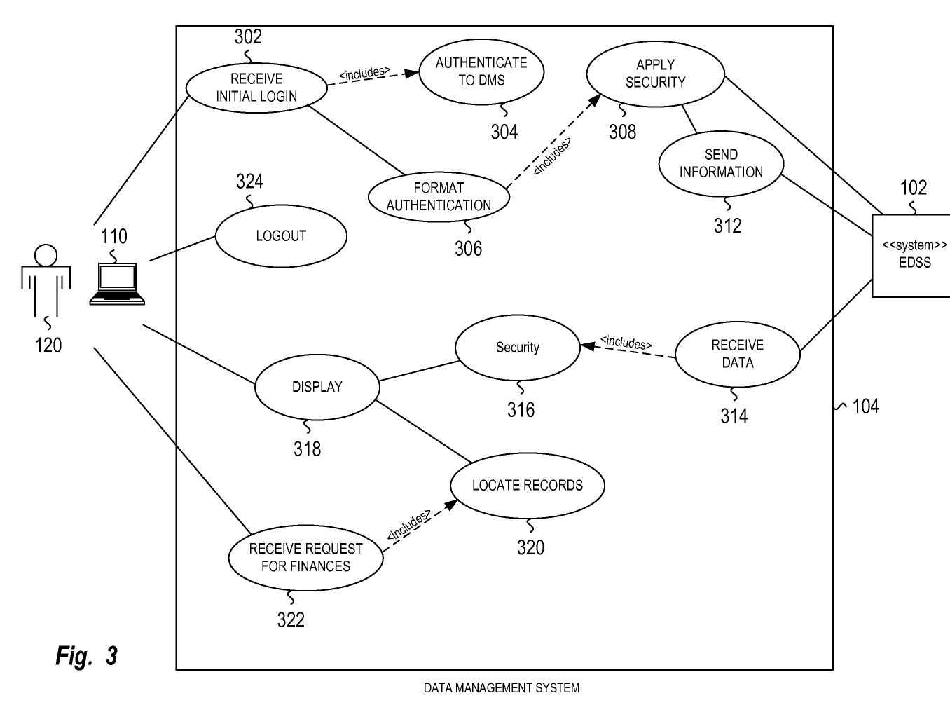

Referring to FIG. 3, a use case diagram of the DMS 104 as used by the document management system is shown. The user 120 interacts with the DMS 104 using personal computer 110 or any of the other devices previously discussed. The user 120 initiates contact with the DMS 104 by sending the user's login information to the DMS 104, which is received at the receive initial login use case 302. The authenticate to the DMS use case 304, authenticates the user 120 to the DMS upon receipt of the login information. The format authentication use case 306 formats the authentication to be passed to the EDSS 102. The formatting varies based on the implementation of both the DMS 104 and the EDSS 102. The apply security use case 308 applies any security mechanisms used by the document management system in reference to the DMS 104. The security mechanisms may include encryption, digital signing, establishing SSL or TLS connections with the EDSS 102 or any other security measures. The login information is sent to the EDSS 102 at the send information use case 312. The receive data use case 314 receives a confirmation of a successful login from the EDSS 102. The information received is encrypted and digitally signed. The security use case 316 is included by the receive data use case 314 and decrypts and checks the digital signature of the confirmation received at the receive data use case 314. The receive request for finances use case 322 receives a request from the user 120 for information contained on the DMS 104. The locate records use case 320 is included by the receive request for finances use case 322 and locates the requested records in the EDSS 102. The display use case 318 displays both the confirmation of login information after the decryption use case 316 and the user information retrieved at the locate records use 318.

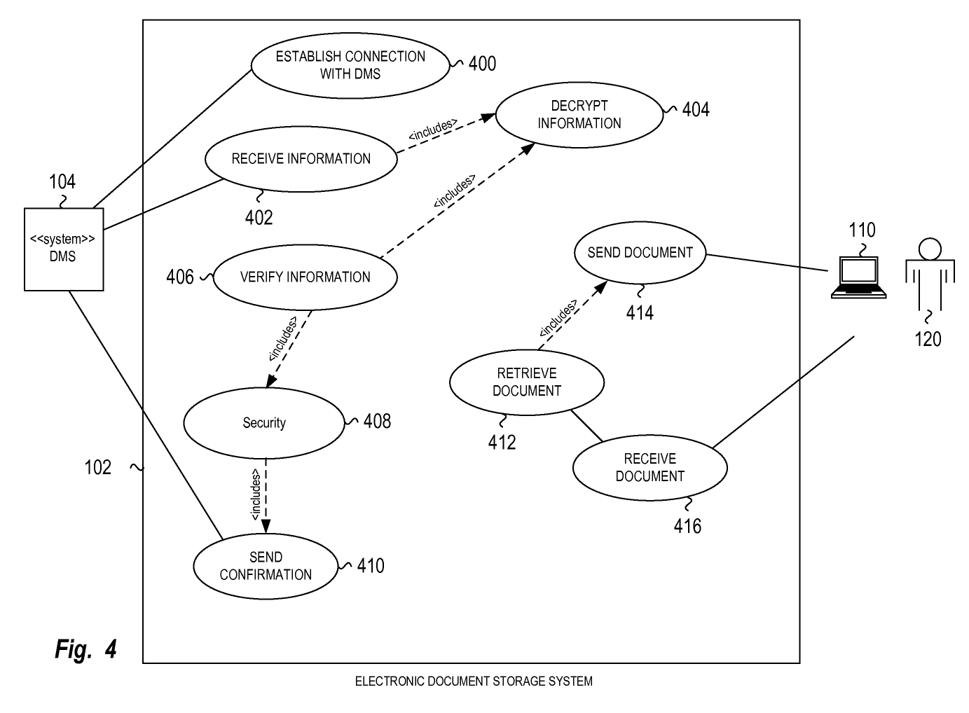

Referring to FIG. 4, a use case diagram of the EDSS 102 is shown as used by the document management system. The establish connection with DMS use case 400 establishes the SSL of TLS connection with the DMS 104 upon initiation by the DMS 104. The receive information use case 402 receives encrypted and digitally signed login information from the DMS 104. The decrypt information use case 404 decrypts the login information received at the receive information use case 402 and checks the digital signature of the login information. The verify information use case 406 is included by the decrypt information use case 404 and verifies that the decrypted login information is valid. The verify information use case 406 also logs the user 120 in the EDSS 102 using the verified information. The security use case 408, creates a confirmation verifying a successful login and encrypts and digitally signs the login to send back to the DMS 104 at the included send confirmation use case 410. The receive document request use case 416 is initiated when a verified user 120 requests a document from the EDSS 102. The retrieve document use case 412 finds the document on the EDSS 102 upon a successful request and the document is sent to the users personal computer 110 at the send document use case 414.

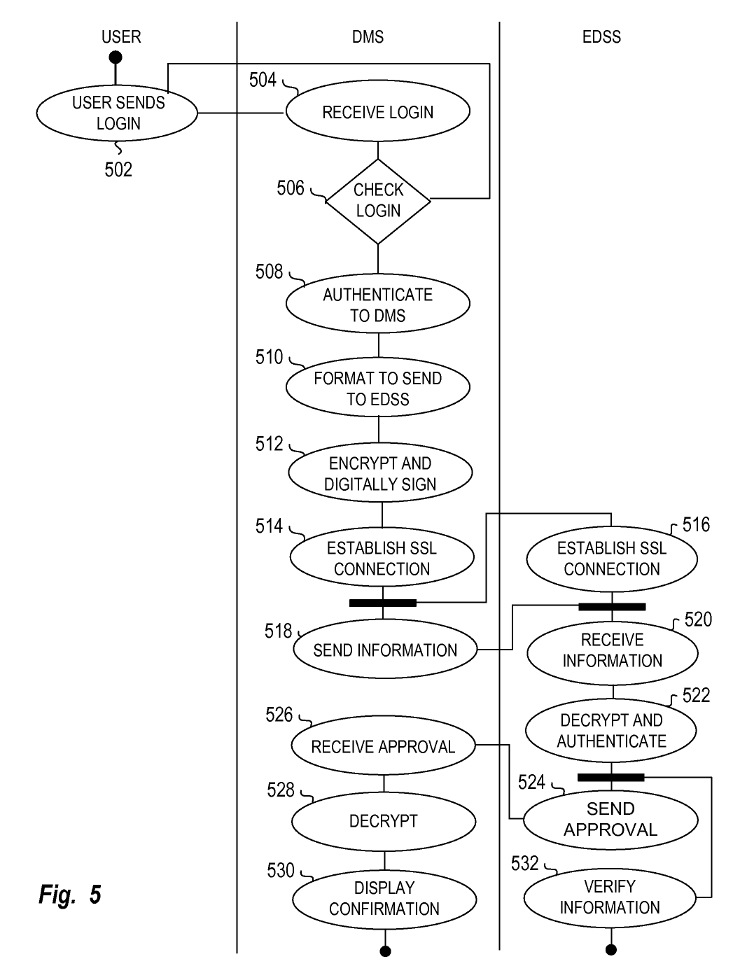

FIG. 5 is an activity drawing for the login process of the document management system. As shown in FIG. 5, the user 120 sends a login to the DMS 102 at user sends login step 502. The receive login step 504 receives the login sent by user 120. The check login test step 506 determines if the login into the DMS 104 is correct. If the login is not correct the user receives a rejection and the process ends. If the login is correct, the authenticate to DMS step 508 authenticates the user 120. The format to send to the EDSS step 510 formats the login information for eventual receipt by the EDSS 102. The encrypt and digitally sign step 512 encrypts and digitally signs the formatted login. The DMS 104 then establishes an SLL or TSL connection with the EDSS 102 at the establish SSL connection steps 514 and 516. Upon successfully establishing of the SSL or TSL connection the DMS 104 sends the encrypted and digitally signed login information to the EDSS 102 at the send information step 518. The information is received at the information step 520. The decrypt and authenticate step 522 decrypts and reads the digital signature of the information received at the receive information step 520 as well as authenticating the user 120 to the EDSS 102. The user 120 is verified at verify information step 520. The send approval step 524 creates and sends an encrypted and digitally signed message confirming the receipt of the login information to the DMS 104. The DMS 104 receives the confirmation at the receive approval step 526. The decrypt step 528 decrypts and reads the digital signature of the confirmation. The confirmation is displayed at the display confirmation step 530.

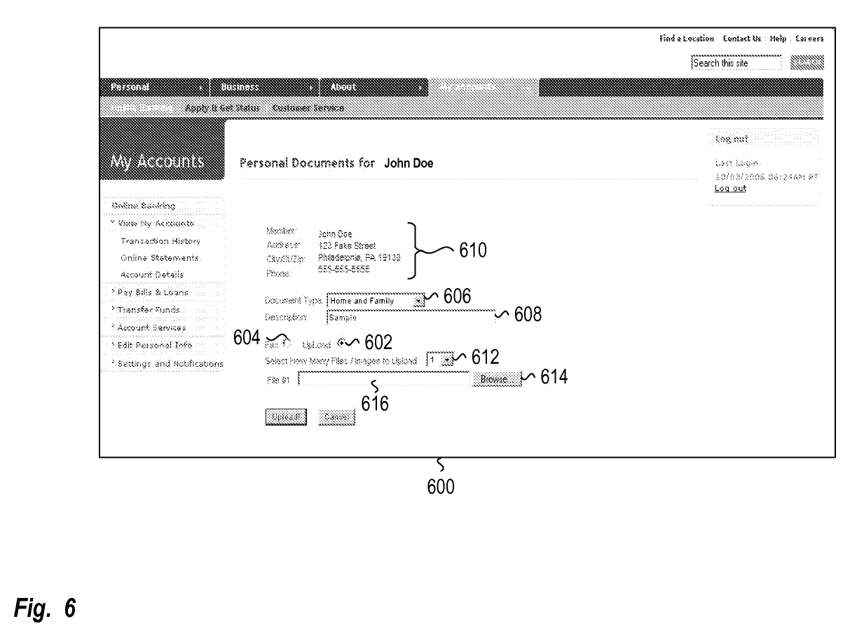

FIG. 6 is an example of a graphical user interface (GUI) that a user 120 is presented with when uploading a document or file. The user 120 is presented with the GUI 600 after the user 120 has gained access to the EDSS 102 using the above described process. The user information 610 shows identifying information pertaining to the user 120. In the example shown this includes the user's name, address and phone number, however it could include e-mail address, Internet protocol address or any other identifying information. The user 120 selects the type of document to be uploaded using the document type menu 606. Document types refer to user created categories or groups used to organize the documents and files contained on the EDSS 102. The example given in GUI 600 is ‘Home and Family’, however a user 120 creates whatever groups they choose, such as ‘work’ or ‘travel’. In the example give, the document type menu 606 is a pull down menu; however it may alternatively be a text box, a series of buttons, a menued system or any other system with the capability to make such a selection. The user 120 optionally inserts a description of the document or file being uploaded by typing the description into the description field 608. The user 120 uses buttons 602 and 604 to select the way the document or file is to be uploaded. In GUI 600, ‘Fax’ and ‘UpLoad’ are shown, where upload refers to all electronic uploads. In alternate embodiments the upload option may include individual electronic uploads such as e-mail, HTML and FTP as well as an option to physically mail the document to the EDSS 102. Additionally, alternate embodiments have selections using pull down menus, text input or other selection devices commonly used in user interfaces. The user 120 selects the number of files being uploaded by using document count menu 612, however any other method of input such as text input can be used. The user 120 selects the document or documents to be uploaded using text box 616 and browse button 614. As described above, any type of file, such as a PDF, a text document, a JPEG or a GIF, can be transmitted to the EDSS 102 using GUI 600. A document which has been selected to be transmitted to the EDSS 102 using GUI 600 is sent to from the user's personal computer 110 to the EDSS 102 and is routed to the user's area in memory based on the user's login information.

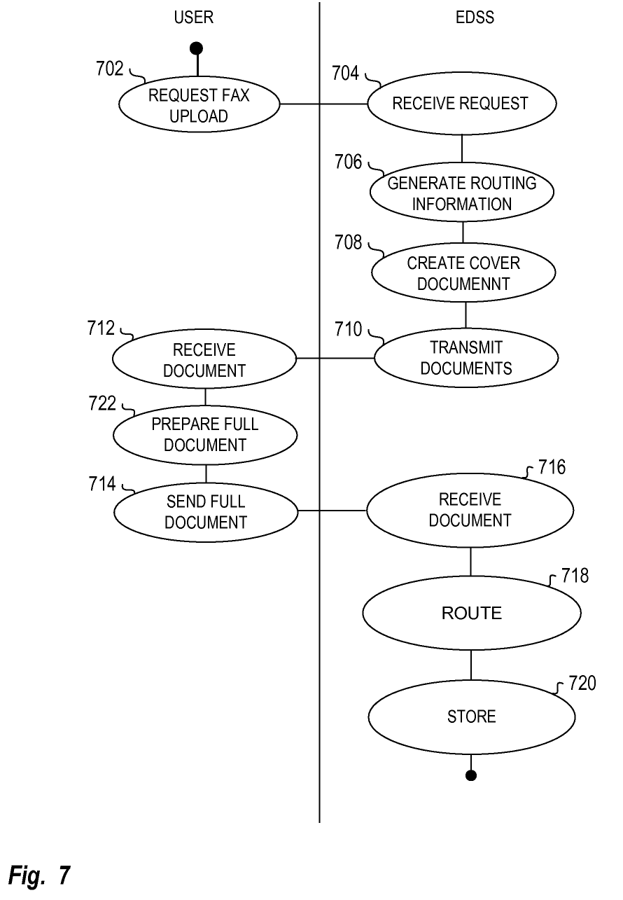

FIG. 7 is an activity diagram for the facsimile uploading process of the document management systems 100 of FIG. 1 and 150 of FIG. 2. In one embodiment a user 120 may choose to upload documents to the EDSS 102 using facsimile technology. When using facsimile uploads, automatically determining where in the EDSS 102 to route the received document to may be accomplished through variety of computer-readable marking devices such as bar codes, optical codes embedded in documents or images, Radio Frequency Identification(RFID) Tags, water marks or similar technology. Any number of mechanisms may be used to embed, encode or append the routing information onto the document. The user 120 requests to begin a facsimile upload at the request fax upload step 702. The request can be in the form of a facsimile, an Internet transmission, an e-mail message a phone call or any other means that facilitate such a request. The EDSS 102 receives this request at the receive request step 704. The generate routing information step 706 generates routing information which identifies the user and user's location in memory within the EDSS 102. The create cover document step 708 creates a cover page containing the routing information including a marking such as a bar code. The routing information identifies the location in the EDSS 102 which corresponds to the user 120. The cover page can be automatically generated by the EDSS 102 or alternatively can be generated by an individual. The transmit document step 710 transmits the cover page to the user. The transmission may occur through a facsimile transmission, a mail delivery, an electronic transmission such as an e-mail, an FTP transfer or other download, or any other transmission method that can securely get the cover page from the EDSS 102 to the user 120. At the receive document step 712, the user 120 receives the document from the EDSS 102 in whichever transmission method was used. At the prepare full document use case 722 the user 120 prepares the document being uploaded and places the cover page on top. At the send full document step 722, the user 120 sends the complete document to the EDSS 102 by sending it through a facsimile. The receive document step 716 receives the document over the facsimile. In one embodiment the facsimile is received electronically and stored for routing. In an alternate embodiment the facsimile is received manually and scanned to a computer before it is stored. The route 718 reads the cover sheet and determines the correct place to route the document in the EDSS 102. The reading is accomplished by analyzing the marking and using the marking to determine the place in memory of the EDSS 102 corresponding to the user 120. The store step 720 stores the document in the EDSS 102 determined by the route 718.

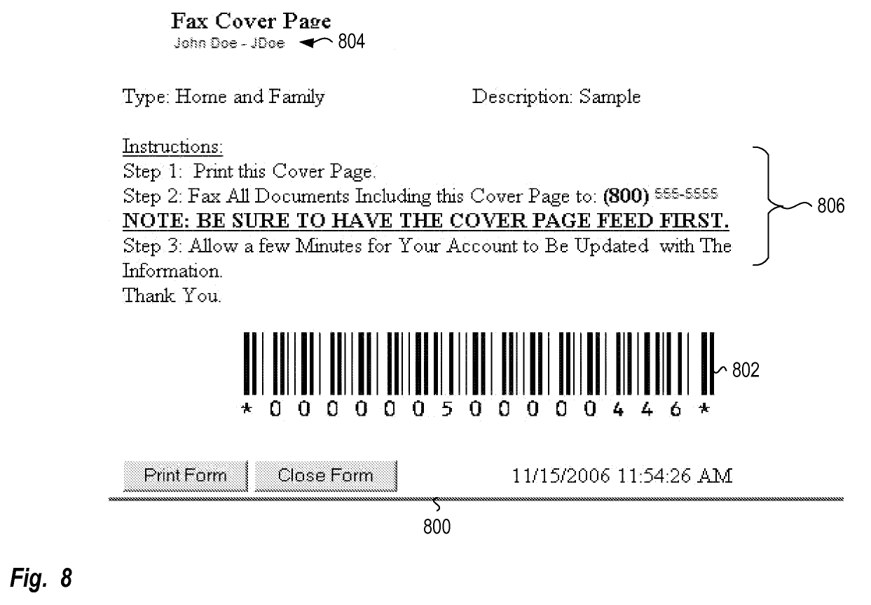

Referring to FIG. 8, an example of a cover page is shown. Cover page 800 contains a bar code 802, identity information 804 and instructions 806. The cover page 800 is a routing document used to route the appended document to the correct location within the EDSS 102. A user 120 receives cover page 800 upon successfully requesting a facsimile upload. The user 120 follows instructions 806 to ensure successful routing of the document to be uploaded. Identity information 804 identifies the user 120. When the cover page 800 is received by the EDSS 102, the EDSS 102 reads bar code 802 to determine the routing information.

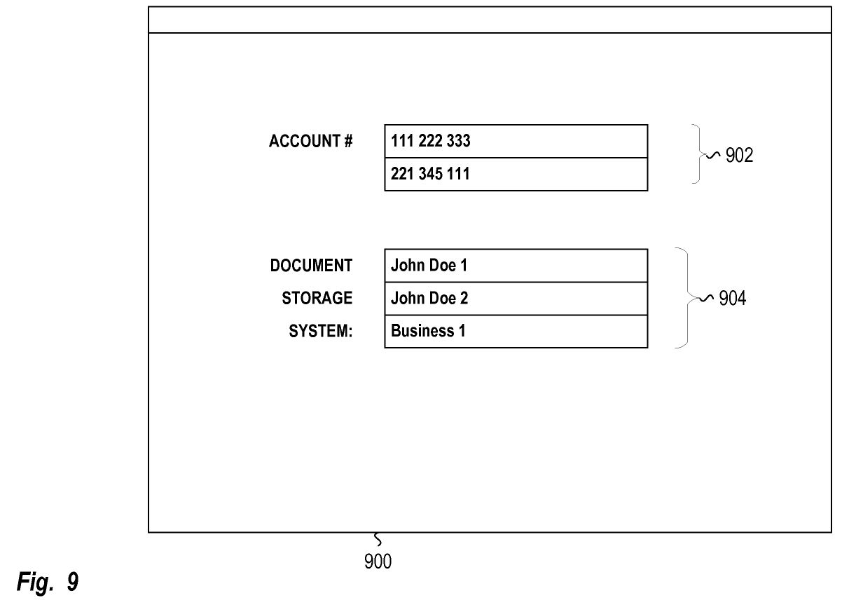

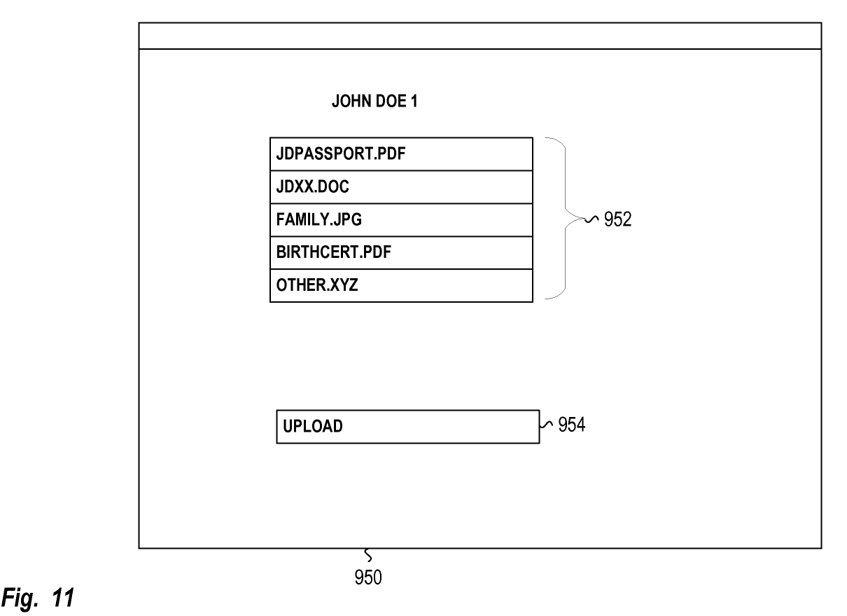

Referring to FIGS. 9 and 11, two example graphical user interfaces are shown. GUI 900 shows an example of the interface presented to a user 120 upon initial login into the DMS 104, where the DMS 104 is a financial data management system. A listing of the financial accounts available to the user 120 are represented by account listings 902. The account numbers allow the user 120 to select which account the user 120 would like to view. Upon selection of any of these accounts, the user 120 is directed to a web site which allows the user 120 to access the user's account information. Document systems listing 904 shows various areas of document storage on the EDSS 102 available to the user 120. In the example shown the user 120 has access to areas on the EDSS 102 labeled ‘John Doe 1,’ ‘John Doe 2,’ and ‘Business.’ The user 120 selects any one of these areas and is directed to the user's documents stored in the corresponding areas. Document areas correspond with locations in memory of the EDSS 102. Upon selection of a document area, the user 120 is logged into the EDSS 102 by the process explained above.

GUI 950, of FIG. 11, shows the interface presented to the user 120 after successfully gaining access to the EDSS 102. The user 120 has access to the uploaded documents listed in document list 952. By clicking on any of these documents, the user 120 can download or view the corresponding documents. The download is secure using the methods described above. The user 120 can choose the method of download including HTML, FTP and e-mail as well as request that the document be faxed to the user 120 or physically mailed to the user 120. Upload button 954 directs the user 120 to the upload screen exemplified by FIG. 6.

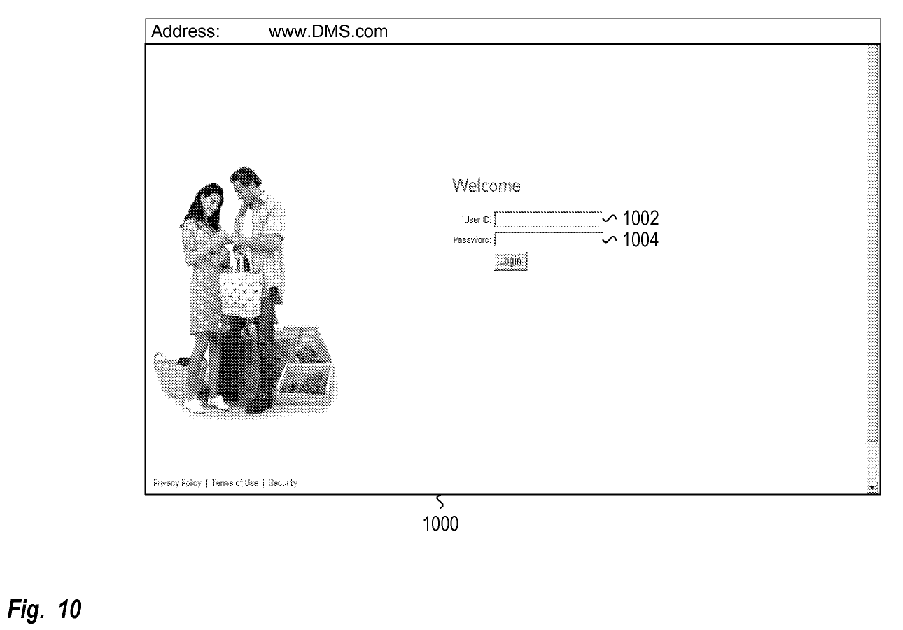

One implementation of the document management system includes the use of websites viewed by the user 120 and back-end systems provided by an administer of the document management system. In this implementation a user initially logs into a client website. The client website may be a financial website such as a banking or credit card company website, a travel itinerary or management website, a membership account website such as a grocery store or other commercial website, a secure portal website or any other website storing user data. An administrator of the document management system maintains a back-end server portal on a server. Additionally, a document storage website is maintained which contains the user's stored documents. As shown in FIG. 10, the user 120 logs into the client website by entering the user's unique username and password into the username location 1002 and password location 1004, respectively. The client website formats the user login data to be passed to the server portal. The client website encrypts and digitally signs the user login data and assembles the data to be passed to the server portal. In one embodiment the data is passed from the client website to the server portal by breaking the data into packets. The client portal also establishes an SSL connection with the server portal. Upon the establishment of the SSL connection, the server portal is sent the signed and encrypted packets by the client website. The server portal decrypts and verifies the user login data and sends it to a back-end authentication application. The back end authentication application creates a token which authorizes the user 120 to have access to information contained on the document website. The token has a limited life for added security. The server portal encrypts and digitally signs the token and sends it back to the client website. The client website decrypts this token and, if proper, gives the user 120 a response indicating a successful login. The server portal also sends this token to the document website for further verification. Upon successful login the user 120 has access to the document website. From the user's perspective, only one login was necessary to gain access to the documents stored on the document website.

As an example of the industrial applicability of the embodiments of the present method and system, users can log onto an account on a secure data management system such as a membership data, financial data, or travel data management system and, upon requesting connection to electronic document storage system, have their logon transferred to the electronic document storage system. The user can then cause data to be uploaded to the system using one of the aforementioned systems including but not limited to e-mail, fax, ftp, physical mail, or other physical or electronic mechanism. In the event that the user is requesting their data, they can access stored documents for viewing on the monitor, for printing, for facsimile transmission to any number of locations (where the user is or to a remote location), for downloading, electronic transmission to a recipient such as through email or through other mechanisms which provide the user with access to their stored documents.

For example, if a user is in a foreign country and loses their passport, they can log onto a relevant system such as their financial management system, which in one example is their credit card account, and obtain access to their electronic documents. In one embodiment the user can have critical documents (e.g. photocopy of the passport, birth certificate) faxed or e-mailed directly to an appropriate agency (e.g. embassy or consulate) in order to have another passport issued. Because the system allows for the flexible routing of documents to locations other then their own, users can manage their documents in a manner appropriate to a particular situation. In one embodiment the user transfers the document from the EDSS 102 through a secure connection to a server, eliminating the possibility that the document has been tampered with in the process of transmission. In an alternate embodiment digital signatures are used in conjunction with the document transfer to authenticate the document. In alternate embodiments the digital signatures are used in steps subsequent to the document transfer to complete part of a process (e.g. passport renewal or re-issuance).

In another example a user logs onto a social networking website, which monitors and maintains lists of friends, pictures or other content representative of the user. This is an example of a membership data management system described above, however other membership data management systems may include employee database websites, company intranets, large chain store websites with mass distribution channels or any other system, which manages data for members of an organization. Once the user has logged onto the social networking website, they are able to have control over their online life via the interface provided by the social networking website. In one embodiment, the social networking website is unified with the EDSS 102 to allow the user to have secure access to the documents stored therein. A social networking website, unified with the EDSS 102 integrates the social networking functionality with the security of the EDSS 102.

In one implementation, the social networking website contains travel information. Users of the social networking website are able to review their travel itinerary, make travel plans, upload photographs of the trip as well as monitor their travel plans. The EDSS 102 is unified with the social networking website, allowing the user to access their documents. For example, a user using a social networking website in this manner will have access to their passport and other official documents from anywhere in the world, including while traveling.

In one implementation of the document management system, official documents and records are submitted directly to the EDSS 102 by the issuing authority, without intervention by the user. An issuing authority is an organization or entity which issues official documents to a user such as a government agency or an insurance company. The official document or record submitted to the EDSS 102 may be an original document, a copy of an original document or an electronic file representing a document. For example, a car insurance company may be an issuing authority, issuing an insurance card to the user through the EDSS 102. A user may access the insurance card electronic through the EDSS 102. If a motorist with an insurance card stored on the EDSS 102 is pulled over by the police, the motorist electronically sends the insurance card from the EDSS 102 to the police via a portable internet capable device such as a PDA or internet capable cell phone.

In an alternate embodiment, the issuing authority is a government agency such as a department of motor vehicles (DMV). The DMV can issue a license or other official documents directly to the EDSS 102 without user submission. In one implementation, the document transmitted to the EDSS 102 is the official copy of the document. The documents are securely stored on the EDSS 102 through the security features discussed above. The documents are encoded and encrypted to ensure authenticity.

The embodiments of the present invention may be implemented with any combination of hardware and software. If implemented as a computer-implemented apparatus, the present invention is implemented using means for performing all of the steps and functions described above.

The embodiments of the present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of the present invention is not limited to the particular examples and implementations disclosed herein, but is intended to cover modifications within the spirit and scope thereof as defined by the appended claims and any and all equivalents thereof.

I/we claim:

1. A method of uploading documents to a secure electronic document storage system, the method comprising:
(a) receiving a request from a user for an upload of at least one document to a secure electronic document storage system;
(b) generating a routing document that includes routing information related to the secure electronic document storage system;
(c) transmitting the routing document to the user;
(d) receiving a facsimile transmission from the user, wherein the facsimile transmission includes the routing document and at least one other document; and
(e) routing the at least one other document to the secure electronic document storage system, based on the routing information contained in the routing document.

2. The method of claim 1, wherein the at least one document is routed to a location in the secure electronic document storage corresponding to the user.

3. The method of claim 1, wherein the at least one document is stored in the secure electronic document storage system in a location based on the routing document.

4. The method of claim 1, wherein the routing information is incorporated at least in part in a bar code.

5. The method of claim 1, wherein the request from the user is received via a facsimile.

6. The method of claim 1, wherein the request from the user is received via the Internet.

7. The method of claim 1, wherein the request from the user is received via a phone call.

8. The method of claim 1, wherein the request from the user is received via an email message.

9. The method of claim 1, wherein the routing information contains information related to the at least one user.

10. The method of claim 1, wherein the routing document is transmitted to the user via a facsimile transmission.

11. The method of claim 1, wherein the routing document is transmitted to the user via an email message.

12. The method of claim 1, wherein the routing document is automatically generated.

13. The method of claim 1, wherein the routing document is generated by an individual.

14. A method of uploading documents to a secure electronic document storage system, the method comprising:
(a) sending a request to a secure electronic document storage system to initiate an upload of a document;
(b) receiving a routing document identifying a location in the electronic document storage system of the upload; and
(c) sending a facsimile transmission to the document management system, the transmission including the routing document and at least one other document to be uploaded to the electronic document storage system.

15. The method of claim 14, wherein the at least one other document is routed to the location in the secure electronic document storage system based on the routing document.

16. The method of claim 14, wherein the request of step (a) is sent via a facsimile.

17. The method of claim 14, wherein the request of step (a) is sent via the Internet.

18. The method of claim 14, wherein request of step (a) is sent via a phone call.

19. The method of claim 14, wherein the request of step (a) is sent via an email message.
